(19) United States
(12) Patent Application Publication
(10) Pub. No.: US 2011/0176972 A1
(43) Pub. Date: Jul. 21, 2011

(54) CELLULAR STRUCTURE CONTAINING ALUMINIUM TITANATE

(75) Inventor: Carine Dien-Barataud, Isle (FR)

(73) Assignee: SAINT-GOBAIN CENTRE DE RECHERCHES ET D'ETUDES EUR, Courbevoie (FR)

(21) Appl. No.: 12/994,456

(22) PCT Filed: May 28, 2009
(86) PCT No.: PCT/FR2009/051004

§ 371 Date: Apr. 11, 2011

(30) Foreign Application Priority Data
May 29, 2008 (FR) 0853530
Jul. 16, 2008 (FR) 0854834

(51) Int. Cl. B01J 8/02; B32B 3/12; B29C 47/00; B29C 71/02; C04B 35/106

(52) U.S. Cl. 422/211; 428/116; 264/630

(57) ABSTRACT

The invention relates to a structure of the honeycomb type, comprising a porous ceramic material based on aluminum titanate, the thermal expansion coefficient of which between 20 and 1000° C. is less than 2.5×10⁻⁶/° C., said structure also having a porosity greater than 10% and a pore size centered between 5 and 60 microns, said structure being characterized in that the composition of the porous ceramic material comprises, by weight, from 30 to 60% of Al₂O₃, from 30 to 60% of TiO₂, from 1 to 20% of SiO₂, less than 10% of MgO, less than 0.5% of oxides from the group Na₂O, K₂O, SrO, CaO, Fe₂O₃, BaO and rare earth oxides, said structure also being characterized in that it has a permanent linear change on reheating, after heating at 1500° C., of less than ±0.3%.

The invention also relates to a catalytic filter or support obtained from such a structure.

The invention relates to the field of filtering structures or catalytic supports, in particular used in an exhaust line of a diesel-type internal combustion engine.

Catalytic filters for the treatment of gases and for eliminating soot particles coming from a diesel engine are well known in the prior art. Usually these structures all have a honeycomb structure, one of the faces of the structure allowing entry of the exhaust gases to be treated and the other face allowing exit of the treated exhaust gases. The structure comprises, between the intake and discharge faces, a set of adjacent ducts or channels with axes parallel with one another separated by porous walls. The ducts are stopped at one or other of their ends to delimit inlet chambers opening on the intake face and outlet chambers opening on the discharge face. The ducts are alternately stopped in an order such that the exhaust gases, as they pass through the honeycomb body, are forced to pass through the side walls of the inlet channels in order to join the outlet channels. In this way, the particles or soot are deposited and accumulate on the porous walls of the filtering body.

In a known manner, during its use, the particulate filter is subjected to a succession of filtration phases (accumulation of soot) and regeneration phases (removal of soot). During the filtration phases, the soot particles emitted by the engine are retained and deposited inside the filter. During the regeneration phases, the soot particles are burnt inside the filter, in order to restore its filtration properties thereto.

Usually, the filters are made of a porous ceramic material, for example cordierite or silicon carbide.

Filters produced with these structures are, for example, described in Patent Applications EP 816 065, EP 1 142 619, EP 1 455 923 or else WO 2004/090294 and WO 2004/065088, to which a person skilled in the art could, for example, refer in order to supplement the present description, both for the description of filters according to the present invention and for the method of obtaining them.

However, certain drawbacks specific to these materials still remain:

as regards the filters made of silicon carbide, a first drawback is linked to the slightly raised thermal expansion coefficient of the SiC, of around 4.5×10⁻⁶ K⁻¹, which does not allow large-sized monolithic filters to be manufactured, and usually requires the filter to be divided into several honeycomb elements joined together by a cement, such as is described in Application EP 1 455 923;
a second drawback, of economic nature, is linked to the extremely high firing temperature, typically greater than 2100° C., necessary to provide a sintering that guarantees a sufficient thermomechanical strength of the honeycomb structures, especially for withstanding, over the entire service life of the filter, the successive regeneration phases. Such temperatures require the installation of special equipment which very substantially increases the cost of the filter finally obtained.

On the other hand, although cordierite filters have also been used for a long time due to their low cost, it is now known that serious problems can arise in such structures, especially during poorly controlled regeneration cycles, during which the filter may be subjected locally to temperatures above the melting point of the cordierite. The consequences of these hot spots may range from a partial loss of efficiency of the filter to its total destruction in the most severe cases. Moreover, cordierite does not have sufficient chemical inertia with respect to the temperatures achieved during successive regeneration cycles and is, therefore, capable of reacting and of being corroded by the metals accumulated in the structure during the filtration phases. This phenomenon may also be a source of the rapid deterioration of the properties of the structure.

Such drawbacks are especially described in Patent Application WO 2004/01124 which proposes, as a solution, a filter based on aluminum titanate for 60 to 90% by weight, reinforced by mullite, present in an amount of 10 to 40% by weight. According to the authors, the filter thus obtained has an improved durability.

According to another embodiment, Patent Application EP 1 741 684 describes a filter having a low expansion coefficient and for which the main aluminum titanate phase is stabilized, on the one hand, by the substitution of a fraction of the Al atoms by Mg atoms in the Al₂TiO₅ crystal lattice within a solid solution and, on the other hand, by substitution of a fraction of the Al atoms at the surface of said solid solution by Si atoms, introduced into the structure by a supplementary intergranular phase of the potassium sodium aluminosilicate type, especially feldspar.

The tests carried out by the Applicant, as reported in the remainder of the description, show however that these materials do not, at the current time, have all the guarantees for use as particulate filters. It has especially been observed that the known filters based on alumina titanate did not have, in normal use as a particulate filter, a service life that is long enough and in particular comparable to that of a silicon carbide filter.

The tests carried out by the Applicant have shown an instability of these structures at high temperature and in particular above 1300° C., typically between 1350° C. and 1500° C., capable of explaining this poor service life. As will be described in greater detail in the remainder of the description, the tests carried out have shown that the materials based on alumina titanate described until now were characterized, after heating at temperatures greater than 1350° C., in particular of 1500° C., by a very high permanent linear change on reheating (often known as PLC in the field of ceramics), which may rise up to values greater than 1% of the initial dimension of the material. This permanent linear change on reheating is accompanied, at a temperature greater than 1350° C., by a shrinkage phenomenon of the material based on alumina titanate, that persists at low temperature, that is to say at a temperature below 400° C., and especially at ambient temperature. The Applicant has found, and it is this which is the subject of the present invention, a novel material based on aluminum titanate, in which the PLC factor is greatly reduced and/or which does not have dilatometric shrinkage at high temperature.

Without this being considered as any one theory, it is possible to estimate that this shrinkage phenomenon, initiated at high temperature and that persists at low temperature, causes intense local internal tensile stresses in the filter, which lead, over time, to damage by creation of macrocracks. Such a phenomenon appears very likely when the filter is subjected to successive heat cycles (regeneration phases) with local temperatures that may be locally much higher than 1350° C., especially in the case of severe regenerations that are poorly controlled if at all. Such severe regenerations, even though they remain rare in absolute terms, are nevertheless frequent on the scale of the service life of a filter, operating in an exhaust line.

The objective of the present invention is thus to provide a honeycomb structure of a novel type, that makes it possible to respond to all of the problems explained previously.

In a general form, the present invention relates to a structure of the honeycomb type, comprising, and preferably composed of, a porous ceramic material based on aluminum titanate, the thermal expansion coefficient (TEC) of which between 20 and 1000° C. is less than 2.5×10⁻⁶/° C., said structure also having a porosity greater than 10% and a pore size centered between 5 and 60 microns, said structure being characterized in that the composition of the porous ceramic material comprises, by weight:
from 30 to 60% of Al₂O₃;
from 30 to 60% of TiO₂;
from 1 to 20% of SiO₂;
less than 10% of MgO;
less than 0.5% of oxides from the group Na₂O, K₂O,
SrO, CaO, Fe₂O₃, BaO and rare earth oxides,
   said structure also being characterized in that it has a permanent linear change on reheating, after heating at 1500° C., of less than ±0.3%, that is to say less than +0.3% and greater than −0.3%.

Preferably, the porous ceramic material based on aluminum titanate also has, after heat treatment at 1500° C., a permanent linear change on reheating (PLC) greater than or equal to −0.1% and preferably greater than or equal to 0. Preferably, the ceramic material based on aluminum titanate has, after heat treatment at 1500° C., a permanent linear change on reheating greater than or equal to −0.1%, very preferably less than or equal to +0.3%.

According to the present invention, the PLC represents, conventionally, the difference in one dimension, for example in the length, of a test specimen of the ceramic material measured before and after the heat treatment at 1500° C., relative to the initial dimension of said test specimen. Conventionally, the PLC corresponds to an elongation if the change is positive, or to a shrinkage, if this change is negative, relative to the initial size before heat treatment.

Preferably, the composition of the porous ceramic material comprises from 35 to 55% by weight of Al₂O₃. Preferably, the composition of the porous ceramic material comprises from 35 to 50% by weight of TiO₂.

Preferably, the composition of the porous ceramic material comprises from 5 to 15% by weight of SiO₂.

Preferably, the composition of the porous ceramic material comprises less than 7.5% by weight of MgO, and more preferably still less than 5% by weight of MgO.

Preferably, the composition of the porous ceramic material comprises less than 0.25% of Na₂O and/or K₂O and/or SrO and/or CaO and/or Fe₂O₃ and/or BaO oxides and/or rare earth oxides in the form of intentional introductions.

In order not to needlessly increase the present description, all the possible combinations according to the invention between the various preferred modes of compositions, such as have just been described above, are not reported but it is clearly understood that all the possible combinations of the preferred fields are envisaged and should be considered as described by the Applicant in the context of the present description (in particular of two, three combinations or more). Such combinations should consequently be understood as included in the present description without it being able, in particular, to be considered as an extension of the present disclosure.

Preferably, the material based on aluminum titanate that is the subject of the present invention has a dimensional change between 1350 and 1500° C. greater than −30%.

Preferably, the porous ceramic material based on aluminum titanate also has a dimensional change between 1350 and 1500° C. greater than or equal to 0%.

Advantageously, said dimensional change between 1350 and 1500° C. does not exceed +100% and very advantageously does not exceed +50%.

The expression “dimensional change between 1350 and 1500° C.” is understood in the sense of the present invention to mean, along one of the dimensions of a test specimen, for example along its length, the difference between said dimension measured at 1500° C. and that measured at 1350° C., relative to said dimension at 1350° C., in the absence of any supplementary compressive load. Conventionally, relative to the reference dimension at 1350° C., this variation, expressed as a percentage, corresponds to an elongation of the material if it is positive, or to a shrinkage if it is negative.

A negative dimensional change, in the sense described previously, corresponds to a shrinkage of the material, in particular parallel to the axis of the filter, corresponding to tensile stresses as described previously, which may in particular lead to cracks in a radial direction.

During the temperature increase phases, the rise in temperature to 1350° C. and 1500° C. is for example by 5° C. per minute, in order to keep the material in thermodynamic equilibrium with the surroundings throughout the heating.

The expression “high-temperature stability” is understood to mean the ability of the material based on aluminum titanate to retain such a structure and in particular its ability not to decompose to two titanium oxide TiO₂ and aluminum oxide Al₂O₃ phases, under the normal usage conditions of a particulate filter.

The expression “ceramic material based on aluminum titanate” is understood, in the sense of the present description, to mean that said material comprises at least 70% by weight and preferably at least 80% by weight, or even at least 90% by weight, of an alumina titanate phase, optionally substituted by silicon atoms and optionally magnesium atoms.

Conventionally, this property is measured according to the invention by a stability test that consists in determining the phases present in the material, typically by X-ray diffraction, then in subjecting it to a heat treatment at 1100° C. for 10 hours and verifying, according to the same method of analysis by X-ray diffraction and under the same conditions, the appearance of the alumina and titanium oxide phases, at the detection threshold of the material.

According to the invention, the material constituting the structure may comprise, besides aluminum titanate, a minimum portion, that is to say less than 10% by weight, or even less than 5% by weight, of mullite Al₆Si₂O₁₃ (3Al₂O₃-2SiO₂) for example from 0.01 to 10% by weight of mullite, preferably from 1 to 5% by weight of mullite. It is important to note that the presence of mullite is not however obligatory according to the invention.

The structures obtained according to the invention have a porosity suitable for use as a particulate filter, that is to say that their porosity is in general between 20 and 65%, preferably between 30 and 60% and the median diameter of the distribution of pores is ideally between 8 and 25 microns.

The filtering structure according to the invention is usually characterized by a central part comprising a honeycomb filtering element or a plurality of honeycomb filtering elements joined together by a joint cement, said element or elements comprising a set of adjacent ducts or channels with axes parallel with one another separated by porous walls, which ducts are stopped by plugs at one or other of their ends to delimit inlet chambers opening on a gas intake face and outlet chambers opening on a gas discharge face, in such a way that the gas passes through the porous walls.

In general, the number of channels is between 7.75 to 62 per cm², said channels having a cross section of 0.5 to 9 mm², the walls separating the channels having a thickness of around 0.2 to 1.0 mm, preferably of 0.2 to 0.5 mm.

The invention also relates to the method of manufacturing a structure as described previously, comprising the mixing of a precursor source of aluminum, of a precursor source of titanium and of a precursor source of silicon, the shaping of the honeycomb structure typically by extrusion and its firing at a temperature preferably between 1300 and 1700° C., the method being characterized in that the precursor source of silicon is chosen from silicon carbide, silicon nitride, silicon oxycarbides or silicon oxynitrides.

For example, said structure is obtained from an initial mixture of silicon grains in the form of at least one silicon carbide powder, a titanium oxide powder and an aluminum oxide powder. Advantageously, the silicon carbide powder has a median diameter of less than 5 microns, preferably between 0.1 and 1 micron and that of the titanium oxide and aluminum oxide powders is less than 15 microns, preferably between 5 and 15 microns.

According to one alternative manufacturing method, the structure according to the invention may also be obtained from an initial mixture of silicon carbide grains, and grains based on aluminum titanate. Advantageously, according to this method, the silicon carbide powder has a median diameter of less than 5 microns, preferably between 0.1 and 1 micron and that of the powder based on aluminum titanate is less than 60 microns, preferably between 5 and 50 microns.

The expression “silicon carbide powder” is understood to mean a powder or granules based on silicon carbide in alpha and/or beta crystallographic form.

The use, according to the invention, in the initial mixture of powders such as SiC, has made it possible to obtain materials for which the performances have never been observed until now. Without being tied to any one theory, such an improvement appears to be directly linked to the use of the grains of SiC (or of another “non-oxide” as described subsequently) as a source of silicon during the step of firing the monoliths, which surprisingly and unexpectedly leads to particularly stable structures, as is shown by the values obtained, in the following examples, for the PLC and for the dimensional change between 1350 and 1500° C., never before observed for materials that are analogous but obtained by other manufacturing processes. It should be noted that according to the invention and unlike the filters described in Application EP 1 741 684, such an improvement of the properties may be obtained without the provision of a supplementary vitreous phase of silico-aluminous compounds, of the feldspar type.

As described previously, the invention is not however limited to SiC and other silicon powders in the non-oxide form may be used instead of SiC, for example silicon oxycarbide and/or oxynitride powders, and preferably silicon nitride powders in alpha and/or beta crystallographic form, since these powders are known for being able to oxidize to an oxide phase during the firing of the initial powder mixture in an oxidizing atmosphere. The use, as a source of silicon, of a mixture of at least two compounds chosen from silicon carbide, silicon nitride, silicon oxycarbides or silicon oxynitrides is also possible according to the invention. Certain adjustments may especially be made as a function of the chemical composition of the powder or powders of silicon in non-oxide form, in particular of the impurities present, of their crystallographic composition and of the median diameter or of the specific surface area of the powder or powders used.

The manufacturing process according to the invention most often conventionally comprises a step of mixing the initial mixture of powders to a homogeneous product in the form of a paste, a step of extruding a green product shaped through a suitable die so as to obtain monoliths of the honeycomb type, a step of drying the monoliths obtained, optionally an assembly step and a firing step carried out in air or in an oxidizing atmosphere at a temperature that does not exceed 1700° C., preferably that does not exceed 1600° C.

For example, during a first step, a mixture comprising at least one powder of silicon carbide, of silicon nitride, of silicon oxycarbide or of silicon oxynitride, a powder of an aluminum titanate or a mixture of titanium oxide and aluminum oxide and optionally from 1 to 30% by weight of at least one pore-forming agent chosen as a function of the size of the desired pores are mixed, then at least one organic plasticizer and/or an organic binder and water are added.

During the drying step, the green monoliths obtained are typically dried by microwave and/or by a heat treatment for a sufficient time to bring the content of water not chemically bound to less than 1% by weight.

The process also comprises a step of closing off one channel in two at each end of the monolith.

In the firing step, the monolith structure is brought to a temperature between about 1300° C. and about 1700° C., preferably between about 1500° C. and 1700° C., in an oxidizing atmosphere, comprising oxygen.

The present invention also relates to a catalytic filter or support obtained from a structure as described previously and by deposition, preferably by impregnation, of at least one supported, or preferably unsupported, active catalytic phase typically comprising at least one precious metal such as Pt and/or Rh and/or Pd and optionally an oxide such as CeO₂, ZrO₂, CeO₂—ZrO₂.

Such a structure finds, in particular, an application as a catalytic support in an exhaust line of a diesel or gasoline engine or as a particulate filter in an exhaust line of a diesel engine.

The invention and its advantages will be better understood on reading the following non-limiting examples. In the examples, all the percentages are given by weight.

### EXAMPLE 1

### According to the Invention

In a mixer, the following were mixed:
50% by weight of an alumina powder having a median diameter of 2.5 microns sold under the reference A17NE by Almatis;
40% by weight of a titanium oxide powder of grade 3025 sold by Kronos; and
10% by weight of a SiC-α powder having a median diameter of about 0.5 micron.

Added, relative to the total weight of the mixture, were 4% by weight of an organic binder of methyl cellulose type, 15% by weight of a pore-forming agent of polyethylene type in powder form having a median diameter of 45 μm, 0.5% of lubricant as an extrusion aid and water so as to obtain, according to the techniques of the art, a homogeneous paste after mixing and the plasticity of which allows the extrusion through a die of a honeycomb structure whose dimensional characteristics are given in table 1:

TABLE 1

| Channel and | Square | |
|---|---|---|
| monolith geometry | | |
| Channel density | 180 cpsi (channels | |
| | per sq. in., | |
| | 1 inch = 2.54 cm) | |
| Wall thickness | 350 | μm |
| Length | 15.2 | cm |
| Width | 3.6 | cm |

The green monoliths obtained were then dried by microwave for a time sufficient to bring the proportion of water not chemically bound to less than 1% by weight.

The channels were alternately closed off on each face of the monolith according to well-known techniques, for example described in Application WO 2004/065088, and with a paste of the same mineralogical composition as the monoliths.

The monoliths were then fired in air gradually until a temperature of 1550° C. was reached, which was maintained for 4 hours.

Analysis by scanning electron microscopy shows a substantially homogeneous structure characterized by the presence of a porous matrix essentially composed of aluminum titanate grains and the characteristics of which are presented in table 2 below.

### EXAMPLE 2

### According to the Invention

In a mixer, the following were mixed:
40% by weight of the alumina powder A17NE;
46% by weight of the titanium oxide powder of grade 3025;
10% by weight of a SiC-α powder having a median grain diameter of around 0.5 micron; and
4% by weight of a magnesia powder having a median diameter of around 10 microns.

Added, relative to this amount of mixture, were 4% by weight of an organic binder of methyl cellulose type, 15% by weight of a pore-forming agent of polyethylene type in powder form having a median diameter of 45 μm, 0.5% of lubricant as an extrusion aid and water so as to obtain a homogeneous paste after mixing and the plasticity of which allows the extrusion through a die of a honeycomb structure as defined previously in example 1.

The monoliths were then dried, plugged then fired according to the same procedure as before.

The analysis by scanning electron microscopy shows a substantially homogeneous structure characterized by the presence of a porous matrix essentially composed of aluminium titanate grains and the characteristics of which are presented in table 2 below.

### EXAMPLE 3

### Comparative

A monolithic structure was synthesized according to the same manufacturing process as that described in the aforegoing example 2, but starting from the mineral composition described in example 6 of Application EP 1 741 684. The mixture of mineral powders from this comparative example does not comprise the addition of SiC powder, the silicon precursor being exclusively introduced in oxide form. On the other hand, the initial mixture comprises, in accordance with the teaching of the prior application EP 1 741 684, an addition of aluminosilicate of plagioclase type.

The characteristics obtained are presented in table 2 below.

### EXAMPLE 4

### Comparative

A monolithic structure was synthesized according to the same process as that described in the preceding example 1, but with the initial mineral composition described in example 5 of U.S. Pat. No. 4,483,944. Unlike the aforegoing example 2, the mixture of mineral powders from this comparative example did not comprise the addition of SiC, the silicon precursor being exclusively introduced in oxide form.

The characteristics obtained are presented in table 2 below.

### EXAMPLE 5

### Comparative

This example is comparable to example 2 but unlike the latter a monolithic structure was synthesized starting from an initial mixture that did not comprise SiC powder.

The composition of the mixture was the following:
43.6% by weight of an alumina powder sold under the reference A17NE, having a median diameter of 2.5 microns, by Almatis;
52.1% by weight of a titanium oxide powder of grade 3025 sold by Kronos; and
4.3% by weight of a magnesia powder having a median diameter of about 10 microns.

Added next, relative to the total weight of the mixture, were 4% by weight of an organic binder of the methyl cellulose type, 15% by weight of a pore-forming agent of polyethylene type in powder form having a median diameter of 45 microns, 0.5% of lubricant as an extrusion aid and water so as to obtain, according to the techniques of the art, a homogeneous paste after mixing and the plasticity of which allows the extrusion through a die of a honeycomb structure as defined previously in example 2.

Table 2 lists the main characteristics measured on the monoliths thus obtained.

The porosity characteristics were measured by high-pressure mercury porosimetry analyses carried out with a Micromeritics 9500 porosimeter.

The weight percentages of the aluminum titanate and mullite phases were determined by X-ray diffraction.

The high-temperature stability of the material was measured according to the stability test described previously.

The weight percentage of the various oxides present in the porous material constituting the product obtained after firing were calculated from the formulation and from the mineral chemical composition of the components of the base mixture.

The filters produced from the monoliths obtained according to examples 1 and 2 according to the invention, loaded with 4 g/l of soot were tested on an engine test bench. It was verified that the filtration efficiency, measured by a probe of SMPS (scanning mobility particle sizer) type was satisfactory and entirely comparable with that of the monoliths obtained according to examples 3 and 4.

Secondly, test specimens, having a cross section of 6×8 mm and a length of 15 mm, of the materials from examples 1 to 5 were extruded and fired at 1550° C. The tests were carried out on test specimens for convenience, the analysis being easier on small bars or test specimens than on extruded monoliths. It is however obvious that the results obtained, as reported below, are uniquely characteristic of the material alone and that identical results would have been obtained if the analysis had been carried out on different forms, in particular on monoliths.

The average thermal expansion coefficient (TEC) from ambient temperature to 1000° C. was measured on these test specimens by dilatometry and along their length, according to techniques well known to a person skilled in the art and at a temperature rise rate of 5° C./min. The measurements were carried out using an Adamel type dilatometer.

The dilatometry recording was continued up to 1500° C. in air in order to measure the dimensional change relative to each of the materials based on alumina titanate between 1350 and 1500° C., in the sense described previously.

The PLC or permanent linear change on reheating was also calculated by analysis of the preceding dilatometric curve and by the recording, after returning to ambient temperature, of the change in dimension of the test specimen, relative to its initial size.

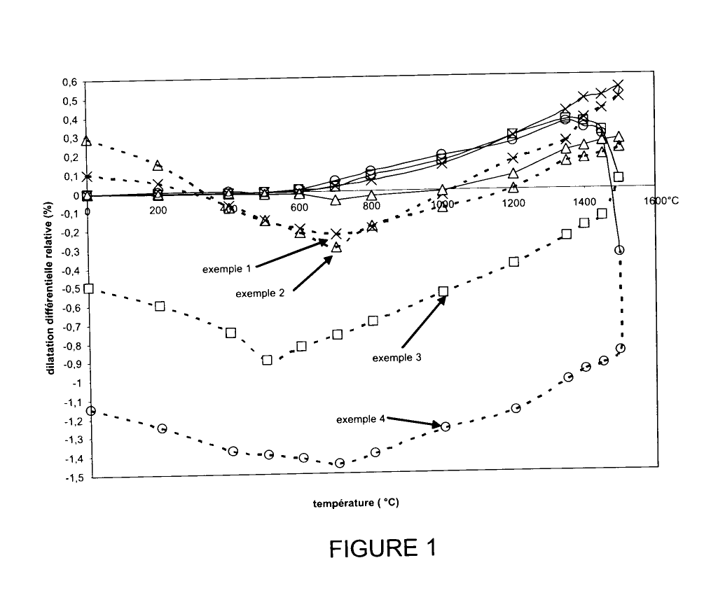

The appended FIG. 1 collates all of the results obtained for the materials from examples 1 to 4. Reported in FIG. 1 as a function of the temperature are the variations in the length of the test specimen, relative to its initial length at 25° C.

In FIG. 1:
the crosses represent the dilatometry measurement points for the material according to example 1;
the triangles represent the dilatometry measurement points for the material according to example 2;
the squares represent the dilatometry measurement points for the material according to example 3;
the circles represent the dilatometry measurement points for the material according to example 4;
the solid-line curves represent the variations in length of the test specimens during the rise in temperature; and
the dotted-line curves represent the variations in length of the test specimens during the cooling thereof.

The main results observed and reported in FIG. 1 are collated in table 2 below:

TABLE 2

| | | | | | |
|---|---|---|---|---|---|
| Examples | 1 | 2 | 3 | 4 | 5 |

Composition of the materials based on Al₂TiO₅

| | | | | | |
|---|---|---|---|---|---|
| Al₂O₃ (wt %) | 47.8 | 37.9 | 26.5 | 65 | 43.5 |
| TiO₂ (wt %) | 37.8 | 43.8 | 62.0 | 25 | 52.0 |
| MgO (wt %) | <0.5 | 3.8 | 10.3 | <0.5 | 4.3 |
| SiO₂ (wt %) | 14.2 | 14.3 | 0.9 | 8.6 | <0.2 |
| Na₂O + K₂O + SrO + | <0.2 | 0.2 | 0.3 | 1.3 | <0.2 |
| CaO + Fe₂O₃ + BaO (wt %) | | | | | |

including:
crystalline oxide phases

| | | | |
|---|---|---|---|
| Aluminum titanate | 95% | 96% | >96% |
| Mullite | 5% | 5% | |
| Spinel | | | 3% |

Properties of the monolith

| | | | | | |
|---|---|---|---|---|---|
| Porosity % | 42 | 44 | 45 | 44 | 44 |
| Median pore diameter | 13 | 14 | 12.5 | 13 | 14.0 |
| (microns) | | | | | |

Properties of the material

| | | | | | |
|---|---|---|---|---|---|
| Dimensional change | +17 | +30 | −89 | −200 | +31 |
| between 1350 and 1500° C. | | | | | |
| (%) | | | | | |
| Permanent linear change | +0.1 | +0.28 | −0.5 | −0.6 | +0.02 |
| on reheating (PLC) after | | | | | |
| treatment at 1500° C. (%) | | | | | |
| Average thermal expansion | 1.5 | −0.2 | 1.4 | 1.5 | 2.3 |
| coefficient (10⁻⁶/° C.) | | | | | |
| Thermal stability test | + | + | + | + | − |
| +: stable | | | | | |
| −: unstable | | | | | |

Table 2 shows that the materials according to the invention (examples 1 and 2) have thermal expansion coefficients that are comparable to those of the existing materials and that are completely compatible with the use as a particulate filter.

Extremely surprisingly, extremely low and positive values of the PLC after treatment at 1500° C. are observed, which are characteristic of the material according to the invention and have never hitherto been observed.

In particular, for the materials based on aluminum titanate of the invention, no shrinkage is observed after returning to ambient temperature. Such a property, combined with a remarkable heat stability of the material, constitutes a significant improvement and makes it possible, in particular, to envisage use of these materials as the main constituent of particulate filters. Such a use makes it possible, in particular, to substantially reduce the risk of the appearance of cracks originating from hotspots in the filter, that is to say caused by temperatures that are locally greater than 1350° C., during poorly controlled regeneration phases. Most particularly, extremely high and negative values of the dimensional change of the materials of the prior art (examples 3 and 4) between 1350 and 1500° C. are observed in table 2, which result in an instability of these materials at high temperature. Such a phenomenon is also expressed by a higher PLC, in the sense described previously. On the other hand, the same change appears positive and very measured for the materials according to the invention (examples 1 and 2), since no dilatometric shrinkage is otherwise observed. As explained previously, this shrinkage phenomenon, initiated at high temperature and persisting at low temperature in the end causes intense and local internal tensile stresses in the filter, which may result in damage by the creation of macrocracks, especially when the filter is subjected to thermal cycling phases with local temperatures greater than 1350° C., which may arise under possible usage conditions of the filter and especially in the case of severe uncontrolled or poorly controlled regenerations.

Moreover, a second heating cycle, carried out on the materials from examples 1 and 4 has shown, respectively, values of the PLC respectively equal to 0 and −0.5% for this second cycle, which shows the superiority and the stability of the materials according to the invention, especially in a use as a particulate filter. Thus, the comparison of the results obtained according to examples 1 and 2 according to the invention and the comparative examples 3 and 4 shows that only the use of a precursor source of silicon in the reduced state, such as SiC, makes it possible to obtain a different material, which is characterized, in particular, by a dimensional change between 1350 and 1500° C., greater than −30% and a value of the PLC, after returning to ambient temperature, between −0.3 and +0.3%. Most particularly, the comparison of the examples provided in the present description shows that the conventional use of a precursor of silicon in oxide form cannot lead to such values.

The comparison of example 5 with example 2 according to the invention, comprising similar Al₂O₃/TiO₂ ratios, shows that the elimination of the precursor source of silicon in the reduced state results in a material which may have a dimensional change between 1350 and 1500° C. and a PLC value that are acceptable. However, such a material, as illustrated by example 5, does not have sufficient thermal stability for the application.

In the aforegoing description and examples, the invention has been described, for reasons of simplicity, in relation to catalyzed particulate filters that make it possible to eliminate gaseous pollutants and soot present in the exhaust gases exiting an exhaust line of a diesel engine.

However, the present invention also relates to catalytic supports that make it possible to eliminate gaseous pollutants exiting gasoline or even diesel engines. In this type of structure, the honeycomb channels are not obstructed at one or other of their ends. Applied to these supports, the implementation of the present invention has the advantage of increasing the specific surface area of the support and consequently the amount of active phase present in this support, without however affecting the overall porosity of this support.

1. A honeycomb structure comprising a porous ceramic material comprising aluminum titanate, wherein the thermal expansion coefficient of said material between 20 and 1000° C. is less than 2.5×10⁻⁶/° C., said structure also having a porosity greater than 10% and a pore size between 5 and 60 microns, wherein the composition of the porous ceramic material comprises, by weight:
from 30 to 60% of Al₂O₃;
from 30 to 60% of TiO₂;
from 1 to 20% of SiO₂;
less than 10% of MgO;
less than 0.5% of at least one oxide selected from the group consisting of Na₂O, K₂O, SrO, CaO, Fe₂O₃, BaO and rare earth oxides,
said structure also comprising a permanent linear change on reheating, after heating at 1500° C., of less than ±0.3%.

2. The honeycomb structure as claimed in claim 1, in which the permanent linear change on reheating, after heating at 1500° C., is greater than 0.

3. The honeycomb structure as claimed in claim 1, in which the porous ceramic material based on aluminum titanate has a dimensional change between 1350 and 1500° C. of greater than −30%.

4. The honeycomb structure as claimed in claim 3, in which the porous ceramic material based on aluminum titanate also has a dimensional change between 1350 and 1500° C. greater than or equal to 0.

5. The honeycomb structure as claimed in claim 1, further comprising, in addition to the aluminum titanate phase, a fraction of less than 10% by weight of mullite Al₆Si₂O₁₃.

6. The honeycomb structure as claimed in claim 1, in which the porosity is between 20 and 65% and the average pore size is between 10 and 20 microns.

7. The honeycomb structure as claimed in claim 1, comprising a central part, wherein the central part comprises a honeycomb filtering element or a plurality of honeycomb filtering elements joined together by a joint cement, said element or elements comprising a set of adjacent ducts or channels with axes parallel with one another separated by at least one porous, wherein the ducts each comprise at least one end, said end being stopped by a plug to delimit an inlet chambers opening on a gas intake face and an outlet chambers opening on a gas discharge face, in such a way that the gas passes through the at least one porous wall.

8. A catalytic filter or support comprising a honeycomb structure as claimed in claim 1 on which at least one supported or unsupported active catalytic phase comprising at least one precious metal such as Pt and/or Rh and/or Pd and optionally an oxide such as CeO₂, ZrO₂, CeO₂—ZrO₂, is deposited or impregnated.

9. A method of manufacturing a structure as claimed in claim 1, comprising mixing a precursor source of aluminum, a precursor source of titanium and a precursor source of silicon, extruding the mixture to produce an extruded mixture and firing the extruded mixture at a temperature between 1300 and 1700° C., wherein the precursor source of silicon is selected from the group consisting of silicon carbide, silicon nitride, silicon oxycarbide or silicon oxynitride.

10. The manufacturing method as claimed in claim 9, in which said mixture comprises grains of silicon carbide, grains of aluminum titanate, grains of silicon carbide, grains of titanium oxide or grains of aluminum oxide.

11. The manufacturing method as claimed in claim 8, in which the initial silicon carbide powder has a median diameter d₅₀ of less than 5 microns.

12. The manufacturing method as claimed in claim 10, in which at least one portion of the silicon carbide grains is replaced by grains of silicon nitride, of silicon oxynitride or of silicon oxycarbide.

13. The method of manufacturing a structure as claimed in claim 9, comprising mixing the mixture in the form of a paste, extruding said paste through a suitable die so as to form monoliths of honeycomb form, drying the monoliths obtained, wherein said mixing and firing are optionally conducted at a temperature between 1300° C. and 1700° C., in an oxidizing atmosphere, comprising oxygen.
